(19) United States
(12) Patent Application Publication
(10) Pub. No.: US 2005/0054470 A1
(43) Pub. Date: Mar. 10, 2005

(54) Planetary gear reducer for preventing vibration

(76) Inventor: Ki-Soo Choun, Busan (KR)

Correspondence Address: ST. ONGE STEWARD JOHNSTON & REENS, LLC, 986 BEDFORD STREET, STAMFORD, CT, 06905-5619, US

(21) Appl. No.: 10/936,145

(22) Filed: Sep. 8, 2004

(30) Foreign Application Priority Data
Sep. 8, 2003 (KR) 20-2003-0028835

(51) Int. Cl. F16H 1/32; F16H 23/00

(52) U.S. Cl. 475/163; 475/181

(57) ABSTRACT

The present invention relates to a planetary gear reducer for preventing vibration, and more particularly, to a planetary gear reducer for preventing vibration which has a pair of external gears eccentric with respect to an input shaft and symmetrical with each other in order to significantly reduce vibration and noise induced from the actuation of the reducer, decrement holes formed in cams to decrease the weight of the cams, thereby reducing moment and vibration, and a pair of balance weights formed symmetrically about the central line of the input shaft to remove dynamic imbalance, thereby advantageously preventing vibration and noise.

This application claims priority of pending Korean Patent Application No. 2003-28835 filed on Sep. 8, 2003.

### FIELD OF THE INVENTION

The present invention relates to a planetary gear reducer for preventing vibration, and more particularly, to a planetary gear reducer for preventing vibration which has a pair of external gears eccentric with respect to an input shaft and symmetrical with each other in order to significantly reduce vibration and noise induced from the actuation of the reducer, decrement holes formed in cams in order to decrease the weight of the cams, thereby reducing moment and vibration, and a pair of balance weights formed symmetrically about the central line of the input shaft to remove dynamic imbalance, thereby advantageously preventing vibration and noise.

### BACKGROUND OF THE RELATED ART

A reducer using a planetary gear includes cams fixedly installed at an input shaft and external gears rotatably installed at the cams. The external gears are constructed in such a manner as to be meshed with the internal gear installed at an output shaft.

However, this structure has a problem in that the weight of the cams eccentric with respect to the input shaft creates vibration which in turn generates noise to the planetary gear reducer as well as degrades mechanical strength thereof.

### SUMMARY OF THE INVENTION

The present invention has been made to solve the foregoing problems occurring in the prior art and it is therefore an object of the present invention to provide a planetary gear reducer which has decrement holes formed in cams to decrease the weight of the cams, thereby reducing moment and vibration, and a pair of balance weights formed symmetrically about the central line of the input shaft to remove dynamic imbalance, thereby advantageously preventing vibration and noise.

It is another object of the present invention to provide a planetary gear reducer which also has balance weights in addition to a external gear for power transmission in order to prevent noise and vibration.

According to an aspect of the invention for realizing the object, there is provided a planetary gear reducer for preventing vibration comprising: an internal gear installed at an output shaft and rotatably fastened with cams installed at the input shaft; a pair of external gears meshed with the internal gear to transmit power and installed eccentrically with respect to the input shaft; and a pair of balance weights installed symmetrically about the central line of the input shaft to remove dynamic imbalance, thereby preventing vibration.

The planetary gear reducer for preventing vibration may further comprise a hollow portion in the output shaft for receiving an auxiliary input shaft extended from an end of the input shaft.

Preferably, each of the cams may comprise a decrement hole to decrease the weight of the cam, thereby reducing vibration.

Preferably, the external gear of the input shaft may be replaced by a balance weight.

### BRIEF DESCRIPTION OF DRAWINGS

The above and other objects, features and advantages of the present invention will be apparent from the following detailed description of the preferred embodiments of the invention in conjunction with the accompanying drawings, in which:

FIG. 1 is a vertical cross-sectional view of a planetary gear reducer according to a preferred embodiment of the present invention;

FIG. 2 is a vertical cross-sectional view of an input shaft and an auxiliary input shaft of the planetary gear reducer according to the preferred embodiment of the present invention;

FIG. 3 is a cross-sectional view taken along the line A-A of FIG. 2;

FIG. 4 is a cross-sectional view taken along the line B-B of FIG. 2;

FIG. 5 is a vertical cross-sectional view of an input shaft and an auxiliary input shaft of a planetary gear reducer according to an alternative embodiment of the present invention; and

FIG. 6 is a vertical cross-sectional view of a planetary gear reducer according to another alternative embodiment of the present invention.

### DETAILED DESCRIPTION OF PREFERRED EMBODIMENTS

As planetary gear reducer for preventing vibration of the present invention will now be described in detail with reference to the accompanying drawings.

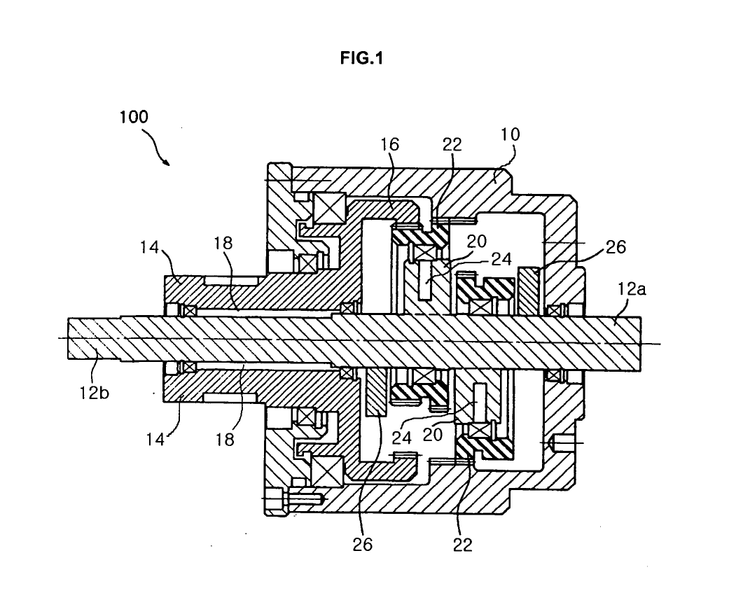

FIG. 1 is a vertical cross-sectional view of a planetary gear reducer according to a preferred embodiment of the present invention. Referring to FIG. 1, a planetary gear reducer for preventing vibration of the present invention includes an internal gear 16 installed at an output shaft 14 and rotatably fastened with cams 20 installed at an input shaft 12a, a pair of external gears 22 meshed with the internal gear 16 to transmit power and installed eccentrically with respect to the input shaft 12a and a pair of balance weights 26 installed symmetrically about the central line of the input shaft 12a in such a fashion as to remove dynamic imbalance to prevent vibration.

Upon the application of power, the input shaft 12a starts to rotate, at which time, the power is transmitted to the output shaft 14 via the cams 20 installed at the input shaft 12a. Then, the power is transmitted to the external gear 22 via the internal gear 16 installed at the output shaft 14 to actuate other mechanical parts.

When a power source gets out of order and stops its operation, the input shaft 12a connected thereto also stops its rotation. Although not shown in the drawings, the input shaft 12a is installed very adjacent to the power source in order to save a space. Accordingly, the length of the input shaft 12a projected from a housing 10 is very short, and thus the input shaft 12a cannot be rotated unless the power source is completely separated from the input shaft 12a.

The present invention additionally provides an auxiliary input shaft 12b at an end of the input shaft 12a in order to rotate the output shaft 14 even in the state where the input shaft 12a is stopped. In addition, a hollow portion 18 is provided in the output shaft 14 in order to install the auxiliary input shaft 12b without increasing the volume of the planetary reducer. That is, the auxiliary input shaft 12b is extended from the input shaft 12a and installed at the hollow portion 18 inside the output shaft 14, and therefore is actuated to rotate the input shaft 12a without separation from the power source.

The cams 20 are installed symmetrically about the central line of the input shaft 12a in order to maintain static balance. The present invention provides decrement holes 24 in the cams 20 since vibration is created from the weight of the cams 20. The decrement holes 24 decrease the weight of the cams 20, thereby reducing vibration induced from the weight of the cams 20.

The cams 20 and the external gear 22 can maintain balance in a static state during the low speed rotation. However, it is difficult to reduce vibration and noise in a dynamic state during the high-speed rotation only with the cams 20 and the external gear 22. Accordingly, a pair of balance weights 26 is provided symmetrically about the central line of the input shaft 12a in order to maintain dynamic balance.

High-speed rotation of the input shaft 12a causes dynamic imbalance, which in turn creates noise and vibration. In particular, torsional vibration originated from high speed rotation functions as a major factor. Uniform distribution of mass is needed to remove torsional vibration. Since moment increases in proportion to distance, the balance weights 26 are placed remote from the center of mass so that optimum dynamic balance can be maintained with a small mass.

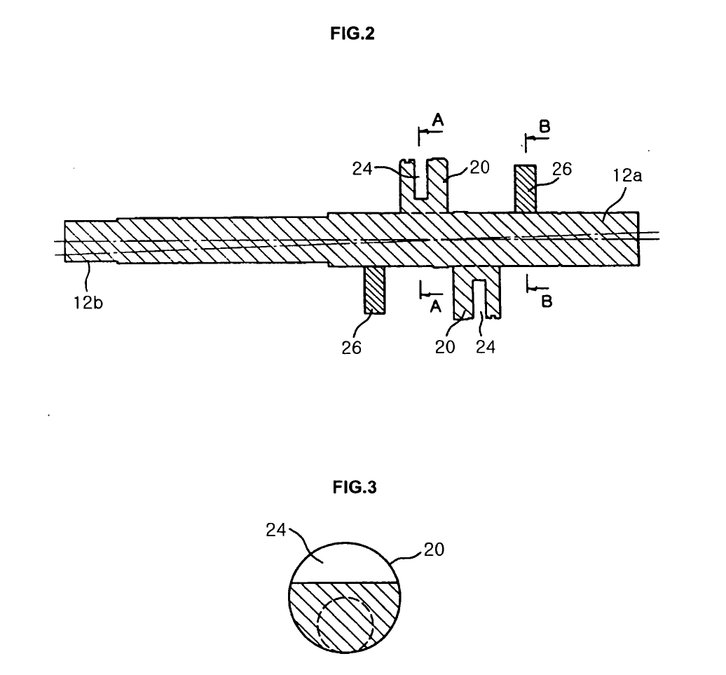

FIG. 2 is a vertical cross-sectional view of an input shaft and an auxiliary input shaft of the planetary gear reducer according to the preferred embodiment of the present invention. Referring to FIG. 2, the cams 20 and the balance weights 26 are provided in the input shaft 12a. In addition, the auxiliary input shaft 12b is provided at the end of the input shaft 12a in order to rotate the output shaft 14 even though the power source stops its operation.

The cams 20 are provided in the input shaft 12a in such a fashion as to be meshed with the internal gear 16. The balance weights 26 are provided in any positions selected from the input shaft 12 where the balance weights 26 can optimize dynamic balance.

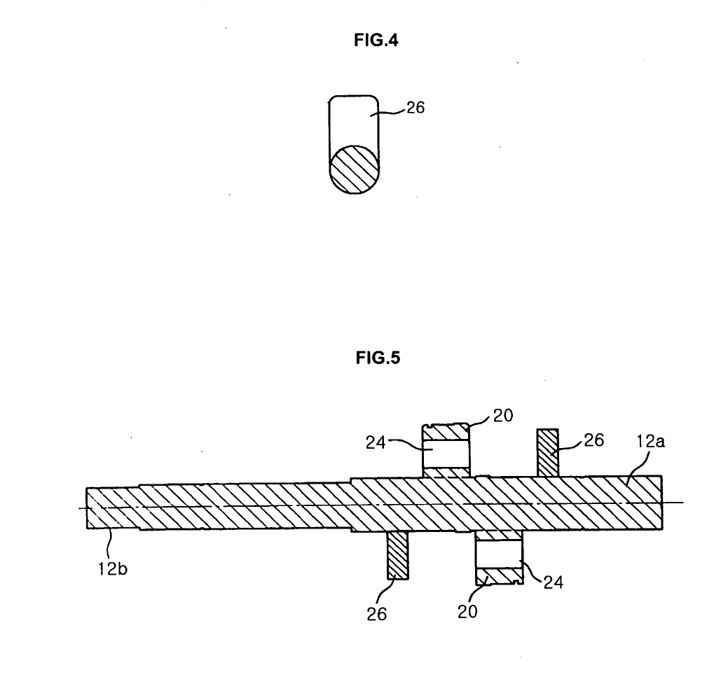

FIG. 3 is a cross-sectional view taken along the line A-A of FIG. 2, and FIG. 4 is a cross-sectional view taken along the line B-B of FIG. 2. Referring to FIG. 3, each decrement hole 24 is realized from a groove in the center of a main edge of each cam 20. The decrement holes 24 reduce the weight of the cams 20. This also reduces moment acting on the input shaft 12a, thereby decreasing torsional vibration.

Referring to FIG. 4, each balance weight 26 is provided in such a fashion as to be in close contact with the input shaft 12a. Moment increases in proportion to the distance from the center of mass. Therefore, the balance weights 26 can function to maintain dynamic balance with only a small mass.

FIG. 5 is a vertical cross-sectional view of an input shaft and an auxiliary input shaft of a planetary gear reducer according to an alternative embodiment of the present invention. Referring to FIG. 5, decrement holes 24 may be provided in parallel with an input shaft 12a.

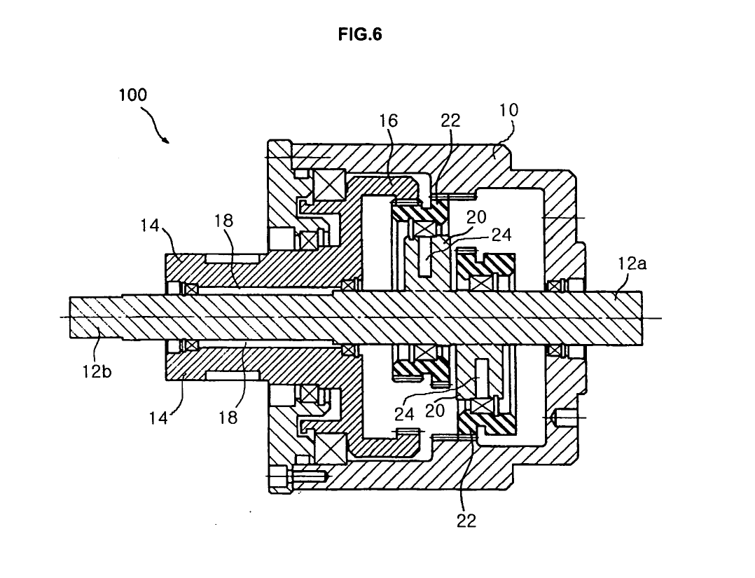

FIG. 6 is a vertical cross-sectional view of a planetary gear reducer according to another alternative embodiment of the present invention. Referring to FIG. 6, a planetary gear reducer for preventing vibration of the present invention includes an internal gear 16 installed at an output shaft 14 and rotatably fastened with cams 20 of an input shaft 12a, and a pair of external gears 22 meshed with the internal gear 16 to transmit power and installed eccentrically with respect to the input shaft 12a.

The pair of the external gears 22 are installed symmetrically with each other to maintain dynamic balance as well as reduce vibration and noise during the rotation of the input shaft 12a.

As described hereinbefore, various technical features and advantages of the present invention have been explained for easier understanding of the accompanying claims of the present invention. Additional features and advantages of the claims will be described hereinafter. It is apparent to those skilled in the art that the principle and specific embodiments of the present invention disclosed as above can be directly applied as bases of design or modification to other structures for implementing various objects similar to that of the present invention.

Furthermore, it will be apparent to those skilled in the art that various changes in form and details may be readily made therein without departing from the spirit and scope of the invention as defined by the appended claims. Therefore, the claims are to be understood to cover any and all applications, modifications and variations within the scope of the present invention as well as all equivalents which will occur equivalent to those skilled in the art.

As set forth above, the planetary gear reducer for preventing vibration of the present invention provides a pair of external gears eccentric with respect to an input shaft and symmetrical with each other in order to significantly reduce vibration and noise induced from the actuation of the reducer.

Moreover, the present invention has decrement holes formed in cams to decrease the weight of the cams, thereby reducing moment and vibration, and a pair of balance weights symmetric about the central line of the input shaft to remove dynamic imbalance, thereby advantageously preventing vibration and noise.

1. A planetary gear reducer for preventing vibration comprising:
an internal gear installed at an output shaft and rotatably fastened with cams installed at an input shaft;
a pair of external gears meshed with the internal gear to transmit power and installed eccentrically with respect to the input shaft; and
a pair of balance weights installed symmetrically about the central line of the input shaft to remove dynamic imbalance, thereby preventing vibration.

2. The planetary gear reducer for preventing vibration according to claim 1, further comprising a hollow portion in the output shaft for receiving an auxiliary input shaft extended from an end of the input shaft.

3. The planetary gear reducer for preventing vibration according to claim 1, wherein each of the cams comprises a decrement hole to decrease the weight of the cam, thereby reducing vibration.

4. The planetary gear reducer for preventing vibration according to claim 1, wherein the external gear of the input shaft is replaced by a balance weight.
